(19) United States
(12) Patent Application Publication
(10) Pub. No.: US 2026/0054205 A1
(43) Pub. Date: Feb. 26, 2026

(54) COMPOSITE FOR CHEMICAL FILTER, PREPARING METHOD THEREOF, AND OUTDOOR AIR CONDITIONER INCLUDING THE SAME

(71) Applicant: Samsung Electronics Co., Ltd., Suwon-si (KR)

(72) Inventors: Seungjun Lee, Suwon-si (KR); Daeok Kim, Suwon-si (KR); Hyeonji Park, Suwon-si (KR); Sewon Jeon, Suwon-si (KR)

(21) Appl. No.: 19/074,678

(22) Filed: Mar. 10, 2025

(30) Foreign Application Priority Data
Aug. 26, 2024 (KR) 10-2024-0114576

(51) Int. Cl. B01D 39/20; B01D 24/00

(52) U.S. Cl. CPC B01D 39/2068; B01D 24/001; B01D 39/2027; B01D 2239/1216; B01D 2279/50

(57) ABSTRACT

The present disclosure relates to a composite for a chemical filter, a preparing method thereof, and an outdoor air conditioner including the same. The composite includes a matrix including porous silica, and a manganese-based oxide impregnated in the matrix. The composite satisfies Equation 1:

$$4.2 \leq {W}_{Mn} / P {V}_{Si} \leq 20 \qquad < Equation 1 >$$

in which W_{Mn} represents wt % of the manganese-based oxide with reference to 100 wt % of the composite for a chemical filter, and PV_{Si} represents a pore volume of porous silica.

### CROSS-REFERENCE TO RELATED APPLICATION

This U.S. non-provisional application claims priority to, and the benefit of, Korean Patent Application No. 10-2024-0114576 filed in the Korean Intellectual Property Office on Aug. 26, 2024, the entire contents of which are hereby incorporated herein by reference.

### BACKGROUND OF THE INVENTION

### (a) Field of the Invention

The present disclosure relates to outdoor air purification. More particularly, the present disclosure relates to a composite for a chemical filter, a preparing method thereof, and an outdoor air conditioner including the same.

### (b) Description of the Related Art

In semiconductor manufacturing processes and display manufacturing processes, air is continuously circulated in fabs such as clean rooms to prevent particles from remaining in the products. However, the air is outdoor air that inflows from outside the fab and may contain chemical contaminants such as acidic gases, base gases, organic sulfur compounds, or volatile organic compounds (VOCs). The chemical contaminants may cause environmental pollution and damage the human respiratory and nervous systems, and may remain as impurities such as particles during the product production, affecting the purity of the products. Research is being actively conducted to remove high concentrations of chemical contaminants inflowing from the outdoor air in the industrial clean room air conditioning equipment used in the semiconductor manufacturing processes or the display manufacturing facilities.

In particular, nitrogen monoxide (NO), a chemical contaminant, has the problem of causing quality issues. In the case of conventional chemical filters, there is a problem in that they are only used for the purpose of removing ammonia (NH₃), ammonium (NH₄), ozone (O₃) and acidic gases, and there is no removal function for nitrogen monoxide (NO) gas. Because nitrogen monoxide (NO) gas in the fab causes the quality issues, alumina impregnated with potassium permanganate (KMnO₄) is being used to impart a nitrogen monoxide removal function to the existing chemical filters. The alumina impregnated with potassium permanganate converts the nitrogen monoxide to nitrogen dioxide, and the concentration of nitrogen monoxide is controlled.

However, in the case of the alumina impregnated with potassium permanganate used in the existing chemical filters, there is a problem that efficiency of processing the nitrogen monoxide is low, and product defects occur due to an increase in the inflow of NOx including nitrogen monoxide and nitrogen dioxide in the fab, particularly in winter when the concentration of NOx in outdoor air is high. In addition, in the case of existing chemical filters, there is a problem that replacement work takes too much time and costs too much due to the short replacement cycle.

Accordingly, there is a need for a composite for a chemical filter that secures the operating rate of the facility and has an improved nitrogen monoxide removal function when outdoor air inflows.

### SUMMARY OF THE INVENTION

The present disclosure provides a composite for a chemical filter with a high removal efficiency of chemical contaminants, such as nitrogen monoxide, when an outdoor air inflow is provided, and having an excellent lifespan.

The present disclosure also provides a method for preparing a composite for a chemical filter.

The present disclosure further provides an outdoor air conditioner including a composite for a chemical filter.

An embodiment of the present disclosure provides a composite for a chemical filter in an outdoor air conditioner including: a matrix including porous silica having at least one pore; and a manganese-based oxide impregnated in the matrix, in which the composite satisfies Equation 1,

$$4.2 \leq {W}_{Mn} / P {V}_{Si} \leq 20 \qquad < Equation 1 >$$

In Equation 1, W_{Mn} represents wt % of the manganese-based oxide with reference to 100 wt % of the composite for a chemical filter, and PV_{Si} represents a pore volume of porous silica.

Another embodiment of the present disclosure provides a method for preparing a composite for a chemical filter in an outdoor air conditioner including: degassing porous silica; preparing an aqueous solution by mixing manganese-based oxide and distilled water; impregnating the aqueous solution in the degassed porous silica; and drying the porous silica impregnated with the aqueous solution including the manganese-based oxide, in which the composite for a chemical filter satisfies Equation 1,

$$4.2 \leq {W}_{Mn} / P {V}_{Si} \leq 20 \qquad < Equation 1 >$$

In Equation 1, W_{Mn} represents wt % of the manganese-based oxide with reference to 100 wt % of the composite for a chemical filter, and PV_{Si} represents a pore volume of porous silica.

Another embodiment of the present disclosure provides an outdoor air conditioner, for example connected to a semiconductor fab and supplying purified outdoor air to the semiconductor fab, including: a housing including an outdoor air inlet and an outdoor air outlet; a prefilter portion in the housing, configured to filter foreign substances from outdoor air input into the housing through the outdoor air inlet; a temperature adjuster in the housing, adapted to heat or cool the outdoor air within the housing; a blower in the housing, configured to supply the outdoor air into a semiconductor fab; and a filter portion in the housing, configured to remove contaminants from outdoor air discharged from the blower, wherein the filter portion includes a chemical filter configured to filter a gas phase in the contaminants, the chemical filter includes a charging layer including a composite for a chemical filter, and the composite for a chemical filter includes a matrix including porous silica and a manganese-based oxide impregnated in the matrix, and the composite satisfies Equation 1.

$$4.2 \leq {W}_{Mn} / P {V}_{Si} \leq 20 \qquad < Equation 1 >$$

In Equation 1, W_{Mn} represents wt % of the manganese-based oxide with reference to 100 wt % of the composite for a chemical filter, and PV_{Si} represents a pore volume of porous silica.

According to embodiments of the present disclosure, the composite for a chemical filter has potassium permanganate (KMnO₄) impregnated in the porous silica to increase the removal efficiency of chemical contaminants, such as nitrogen monoxide, for example, when outdoor air is input into an outdoor air conditioner, and to increase the lifespan of the composite.

According to other embodiments of the present disclosure, the method for preparing a composite for a chemical filter provides a method for preparing a composite for a chemical filter having the advantages described herein.

According to other embodiments of the present disclosure, the outdoor air conditioner may improve the removal efficiency of chemical contaminants, such as nitrogen monoxide, inflowed from the outdoor air into an outdoor air conditioner, by including a composite for a chemical filter having the advantages described herein.

### BRIEF DESCRIPTION OF THE DRAWINGS

FIG. 1 shows a cross-sectional view of a fab connected to an outdoor air conditioner according to an embodiment of the present disclosure.

FIG. 2 shows an enlarged cross-sectional view of an outdoor air conditioner of FIG. 1.

FIG. 3 shows a perspective view of a chemical filter of FIG. 2, and

FIG. 4 shows a cross-sectional view of a chemical filter of FIG. 3 with respect to a line AA′.

FIG. 5 shows a composite in a chemical filter of FIG. 4.

FIG. 6 shows an enlarged perspective view of a chemical filter according to another embodiment of the present disclosure.

FIG. 7 shows a flowchart of a method for preparing a composite for a chemical filter according to an embodiment of the present disclosure.

FIG. 8 shows photographs before and after impregnation of a catalyst in a method for preparing a composite for a chemical filter according to an embodiment and a comparative example of the present disclosure.

FIG. 9 shows a graph of removal efficiency of NO with respect to time according to an embodiment and a comparative example of the present disclosure.

FIG. 10 shows an XRD (X-ray diffraction) graph on a composite for a chemical filter according to an embodiment and a comparative example of the present disclosure.

### DETAILED DESCRIPTION OF THE EMBODIMENTS

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

Parts that are irrelevant to the description will be omitted to clearly describe the present disclosure Same elements will be designated by the same reference numerals throughout the specification.

The size and thickness of each configuration shown in the drawings are arbitrarily shown for better understanding and ease of description, but the present invention is not limited thereto. In the drawings, the thickness of layers, films, panels, regions, etc., are enlarged for clarity. For better understanding and ease of description, the thicknesses of some layers and areas are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. The word “on” mean positioned on, above, or below the object portion, and does not necessarily mean positioned on an upper side of the object portion based on a gravitational direction.

Spatially relative terms, such as “below,” “top,” “bottom,” “front,” “rear,” and the like, may be used herein for ease of description to describe positional relationships, such as illustrated in the figures, for example. It will be understood that the spatially relative terms encompass different orientations of the device in addition to the orientation depicted in the figures.

It will be understood that when an element is referred to as being “connected” to another element, it can be directly connected to the other element or intervening elements may be present.

When a component is described as “including” or “comprising” a particular element or group of elements, it is to be understood that the component is formed of only the element or the group of elements, or the element or group of elements may be combined with additional elements to form the component, unless the context indicates otherwise.

The phrase “in a cross-sectional view” means viewing a cross-section of which the object portion is vertically cut from the side.

Items described in the singular herein may be provided in plural, as can be seen, for example, in the drawings. Thus, the description of a single item that is provided in plural should be understood to be applicable to the remaining plurality of items unless context indicates otherwise.

As used herein, the term “and/or” includes any and all combinations of one or more of the associated listed items.

Hereinafter, several embodiments of the present disclosure will be described in detail so that those skilled in the art to which the present disclosure pertains may easily practice the present disclosure. However, the present invention may be implemented in various different forms and is not limited to embodiments provided herein.

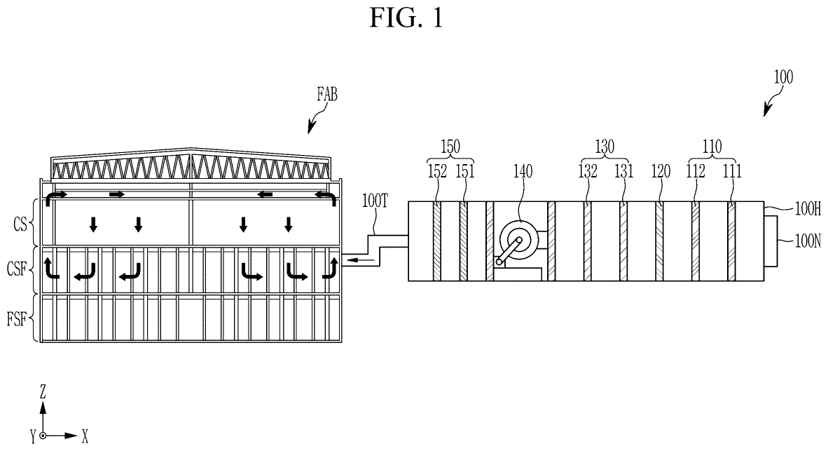

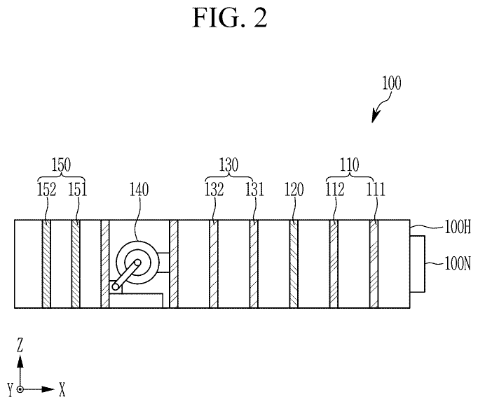

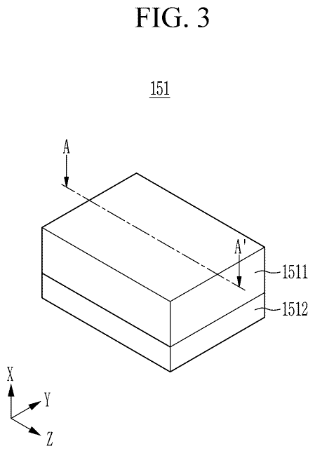

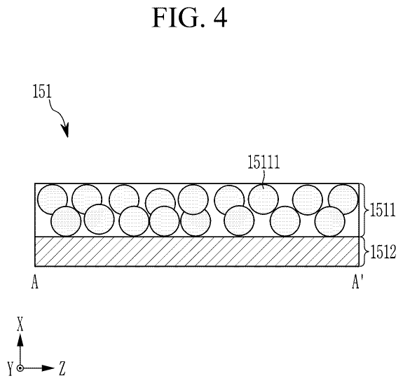

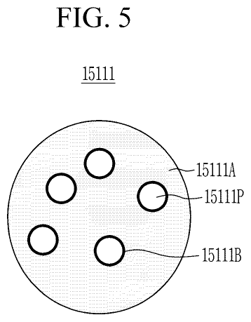

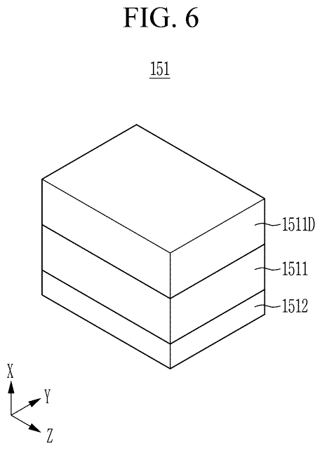

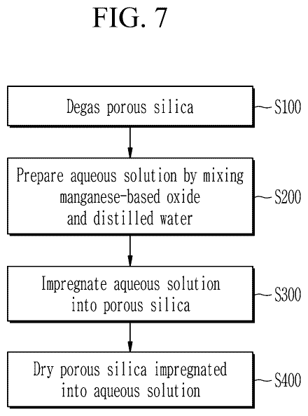

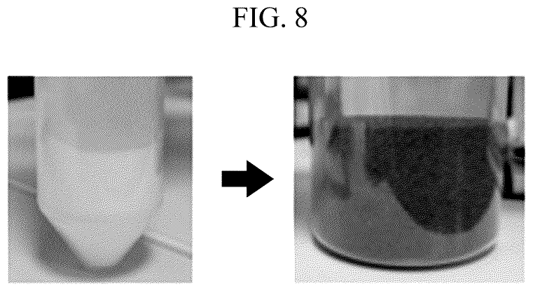

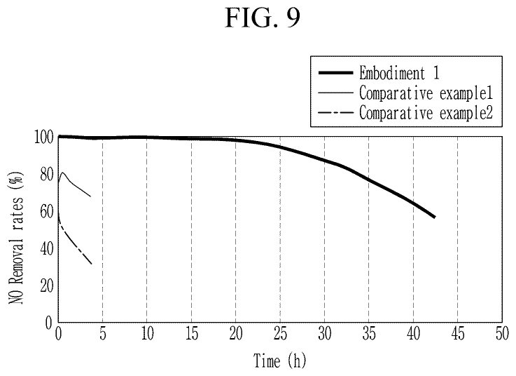

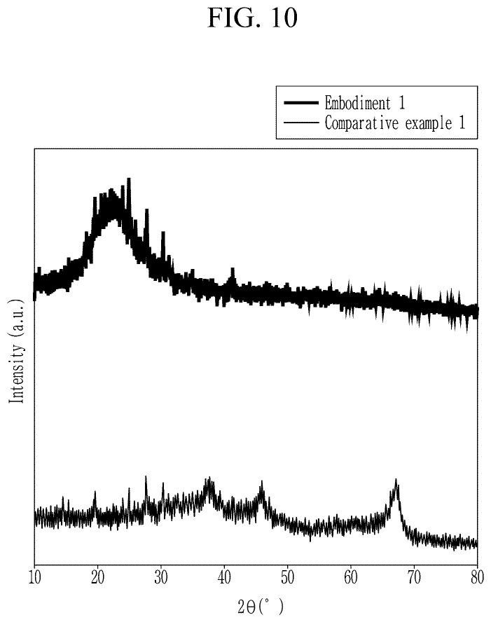

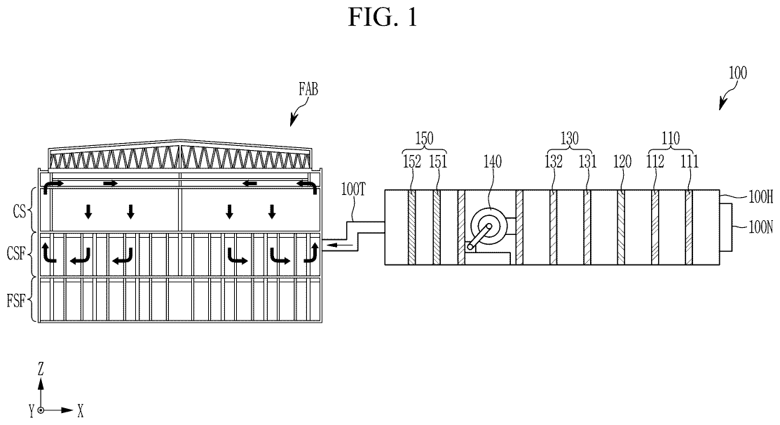

FIG. 1 shows a cross-sectional view of a fab connected to an outdoor air conditioner according to an embodiment of the present disclosure.

Referring to FIG. 1, the fab may include for example, a clean room CS, a clean sub-fab CSF arranged below the clean room CS and circulating outdoor air on an inside and an outside, and a facility sub-fab FSF arranged below the clean sub-fab CSF. Auxiliary facilities for the fab may provide materials needed to process, for example, gas and chemical materials or remove or exhaust remaining chemical materials. FIG. 1 shows a case where the clean sub-fab CSF and the facility sub-fab FSF are stacked and arranged, but this is a non-limiting example, and the clean sub-fab CSF and the facility sub-fab FSF may be stacked in a perpendicular direction, may be stacked in a horizontal direction, or may be integrated to form a single layer.

In an embodiment, the fab is connected to an outdoor air conditioner 100 for supplying outdoor air to the inside of the fab. The outdoor air conditioner 100 may circulate purified air in the fab by purifying outdoor air and supplying it into the fab. For example, the outdoor air conditioner 100 may provide purified air (or fresh air) by removing the chemical contaminants in the outdoor air using filter members and temperature control members.

In an embodiment, the outdoor air conditioner 100 may be directly connected to at least some regions in the fab. For example, outdoor air supplied through an inlet 100N may be supplied into the fab through an outlet 100T. The outlet 100T may be connected to at least one region among the clean room CS, the clean sub-fab CSF, or the facility sub-fab FSF in the fab. For example, the outlet 100T may be directly supplied to the clean sub-fab CSF, and then purified air may be supplied and circulated to the clean room CS according to the air circulation flow in the fab.

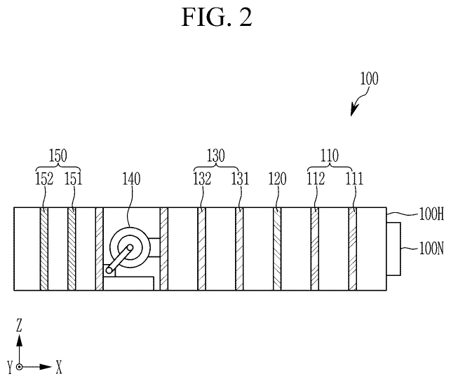

FIG. 2 shows an enlarged cross-sectional view of an outdoor air conditioner 100 of FIG. 1.

Referring to FIG. 2, the outdoor air conditioner 100 may include a prefilter portion 110, a preheater 120, a temperature adjuster 130, a blower 140, and a filter portion 150. The outdoor air conditioner 100 includes filter portions and a temperature adjuster, thereby purifying outdoor air including chemical contaminants and easily supplying purified air to the fab.

In an embodiment, the outdoor air conditioner 100 may include a housing 100H including an outdoor air inlet 100N through which outdoor air flows and an outdoor air outlet 100T through which outdoor air is discharged. The housing 100H may seal the outdoor air conditioner 100 so that outdoor air may be inflowed and easily supplied to the fab, and may minimize damage and influence from the outside of the outdoor air conditioner 100. The housing 100H may be a material including at least one material from among metal, ceramic, plastic, or polymer, but this is a non-limiting example and it may include various materials that function as the herein-described outdoor air conditioner 100.

In an embodiment, the outdoor air inlet 100N may be arranged in at least a predetermined region of the outdoor air conditioner 100 as a cross-sectional reference. For example, the outdoor air inlet 100N may be placed in the same region as the cross-section of the outdoor air conditioner 100, i.e., the front, and the outdoor air inlet 100N may be placed in a predetermined region of the cross-section of the outdoor air conditioner 100. This is a non-limiting example and may be implemented in a variety of ways depending on the equipment application.

In an embodiment, the outdoor air outlet 100T may have a pipe shape to connect the outdoor air conditioner with the fab. The outdoor air outlet 100T may have a tube shape to facilitate connection with the fab. In an embodiment, the outdoor air outlet 100T may be directly connected to the end of the fab from the end of the outdoor air conditioner 100, and may easily supply the outdoor air input from the outdoor air inlet 100N and purified to the fab. FIG. 1 shows that the cross-sectional shape of the outdoor air outlet 100T includes a predetermined curved region, but this is a non-limiting example, and when it includes no curved region, the cases where multiple curved regions are included may be included.

The prefilter portion 110 may be a filter member for filtering foreign substances in the outdoor air that flows in through the outdoor air inlet 100N. The prefilter portion 110 may filter foreign substances of relatively large particles contained in the outdoor air. For example, the prefilter portion 110 may filter the foreign substances of large particles using a mesh filter.

In an embodiment, the prefilter portion 110 may include a prefilter 111 and a bag filter 112. The prefilter 111 may filter the outdoor air first from among the outdoor air input to the outdoor air conditioner, and may be a member for removing large particles and dust. For example, the prefilter 111 may be a member for preventing contamination of subsequent filters by removing large particles and dust, such as large dust or insects.

The bag filter 112 filters out smaller particles that the prefilter 111 fails to remove from the outdoor air having passed through the prefilter 111. The bag filter 112 removes medium-sized particles. The bag filter 112 may be bag-shaped, which increases dust collection efficiency and allows it to process more outdoor air and particles. Because of this, it may be effectively used in systems where large amounts of outdoor air are supplied.

The preheater 120 may be arranged behind the prefilter portion 110 to control the temperature or the temperature of the outdoor air. The preheater 120 may raise the temperature of the outdoor air in advance when the temperature of the outdoor air is cold, such as in winter, to prevent the rear filters or other devices from being damaged or having their performance deteriorated by the excessively cold outdoor air, and thereby maintain a constant temperature in the fab.

The preheater 120 may prevent condensation from being generated when the excessively cold outdoor air passes through the rear filter. In this way, the preheater 120 may increase the energy efficiency of the outdoor air conditioner by preheating the outdoor air and assisting the subsequent cooling and heating devices to reach the target temperature using less energy.

The temperature adjuster 130 may be a member for heating or cooling the outdoor air. For example, the temperature adjuster 130 may include a heating coil 131 for heating the outdoor air and a cooling coil 132 for cooling the outdoor air. The temperature adjuster 130 may control the temperature inside the fab consistently by controlling the temperature of the outdoor air appropriately according to the season, thereby ensuring the work condition in the fab and the product quality.

The heating coil 131 is a member for heating the outdoor air and increasing the temperature of the air entering the fab. The heating coil 131 may heat the outdoor air using, for example, hot solvent or vapor.

The cooling coil 132 is a member for cooling the outdoor air and lowering the temperature of the air entering the fab. The cooling coil 132 may, for example, circulate cold water or refrigerant to lower the temperature of the outdoor air.

In an embodiment, the outdoor air conditioner 100 may further include a humidity adjuster for controlling humidity in the outdoor air. The outdoor air conditioner 100 may include a humidifier for increasing humidity in the outdoor air and a dehumidifier for reducing humidity in the outdoor air.

In this way, the outdoor air conditioner 100 may easily control the temperature and humidity of the outdoor air by including the temperature adjuster 130 and/or the humidity adjuster, thereby easily controlling the temperature and humidity of the fab.

The blower 140 may be a member for circulating air and drawing outdoor air into the fab. The blower 140 may be connected to the rear of the temperature adjuster 130 and may supply the outdoor air having passed through the prefilter portion 110 and the temperature adjuster 130 to the inside of the fab. For example, the blower 140 may be implemented in a known form, such as a fan or an exhaust fan.

The filter portion 150 includes a chemical filter 151 for filtering a gas phase in the contaminants. The chemical filter 151 may efficiently remove the gas phase from among the contaminants included in the outdoor air. he gas phase of the contaminants may include gases such as nitrogen monoxide (NO), nitrogen dioxide (NO₂), ammonia (NH₃), ammonium (NH₄), and ozone (O₃). The chemical filter 151 of the present disclosure may increase the treatment efficiency of nitrogen monoxide among the contaminants.

In an embodiment, the filter portion 150 may include a HEPA Filter 152 for removing the contaminants having passed through the chemical filter 151. The HEPA filter 152 may remove particulate particles that are not filtered through the chemical filter 151 in the contaminants.

In an embodiment, the outdoor air conditioner 100 may further include a damper for controlling the flow of air. The damper may control and regulate air flows, and may maintain the pressure inside the fab by adjusting the amount of outdoor air flowing into the outdoor air conditioner 100.

In an embodiment, the outdoor air conditioner 100 may further include an air mixing chamber. The air mixing chamber may be a space in which outdoor air is mixed with indoor air. The air mixing chamber may mix outdoor air and indoor air and may control the temperature and humidity before supplying it to the fab, thereby circulating air with a uniform temperature and humidity in the fab, and thereby minimizing the impact on product quality.

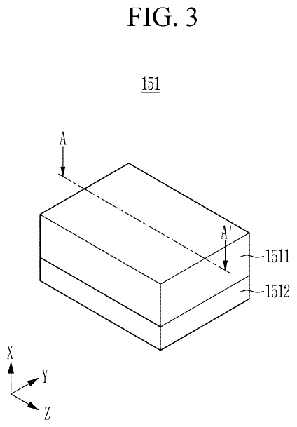

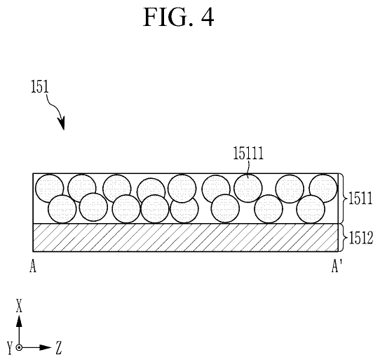

FIG. 3 shows a perspective view of a chemical filter 151 of FIG. 2, and FIG. 4 shows a cross-sectional view of a chemical filter 151 of FIG. 3 with respect to a line AA′.

Referring to FIG. 3 and FIG. 4, the chemical filter 151 may include a charging layer 1511 including at least one composite for a chemical filter 15111. The at least one composite for a chemical filter 15111 may be filled and arranged in the charging layer 1511. When the outdoor air passes through the chemical filter 151, the contaminants in the outdoor air, such as nitrogen monoxide, is changed into nitrogen dioxide, and the composite for a chemical filter 15111 may easily remove the nitrogen monoxide.

The chemical filter 151 may include a buffer layer 1512 arranged on at least one surface of the charging layer 1511, the charging layer 1511 including a composite for a chemical filter 15111. The buffer layer 1512 supports the chemical filter 151 and fixes the outdoor air conditioner 100 on the inside. The buffer layer 1512 may be arranged on a surface of the charging layer 1511, such as one surface of the charging layer 1511, and may fix the motion of the composite for a chemical filter 15111 by the outdoor air.

In another embodiment, the buffer layer 1512 may be arranged on both surfaces of the charging layer 1511. The buffer layer 1512 may be arranged on multiple surfaces of the charging layer 1511, such as two surfaces, to easily support the composite for a chemical filter 15111 in the charging layer 1511 and allow air to pass through.

In an embodiment, the buffer layer 1512 may support the composite for a chemical filter 15111 and may allow the outdoor air to pass through. The buffer layer 1512 is a non-limiting example, and may have various forms such as a mesh form, porous form, or a form including hollow portions through which the outdoor air may pass.

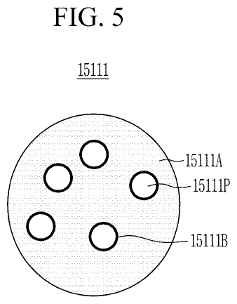

FIG. 5 shows a composite 15111 in a chemical filter of FIG. 4.

Referring to FIG. 5, in an embodiment, the composite for a chemical filter 15111 may include a matrix 15111A including porous silica and a manganese-based oxide 15111B impregnated in the matrix 15111A. The composite for a chemical filter 15111 represents at least one composite for a chemical filter 15111 arranged in the charging layer 1511 of the chemical filter 151 in the outdoor air conditioner. The composite for a chemical filter 15111 may be formed by impregnating the manganese-based oxide 15111B that is an oxidizing agent on the matrix 15111A including porous silica.

In an embodiment, the matrix 15111A may be formed by agglomerating and arranging porous silica. The composite for a chemical filter 15111 may have a matrix form by agglomerating the porous silica.

The porous silica may represent silica (SiO₂) having fine pores. The porous silica is a non-limiting example, and may include at least one of silica gel, MCM-41, MCM-48, KIT-6, and/or SBA-15.

In an embodiment, the porous silica may have 325 to 600 m²/g of the BET (Brunauer-Emmett-Teller) specific surface area. The BET specific surface area may be 350 to 550 m²/g. As used herein, the term “specific surface area” refers to the total surface area of pore walls within a porous material, divided by the volume of the porous material.

As the BET specific surface area satisfies the herein-described range, it may have a superior surface area, as compared to a matrix form using conventional alumina (Al₂O₃), and gas, such as nitrogen monoxide, is easily removed. Further, as the BET specific surface area satisfies the herein-described range, dispersion of the oxidizing agent increases, the oxidizing agent is easily supported or impregnated in the matrix including the porous silica, and the gas phase such as the nitrogen monoxide is easily removed.

When the BET specific surface area digresses from an upper value of the present range, the composite for a chemical filter 15111 becomes excessively big, and filling density of the composite 15111 in the charging layer is lowered. When the BET specific surface area digresses from a lower value of the present range, the efficiency of removing chemical contaminants of the composite for a chemical filter 15111, the nitrogen monoxide is deteriorated.

In an embodiment, the porous silica may have a pore volume of 0.5 to 1.2 cm³/g. The porous silica may have the pore volume of 0.6 to 1.2 cm³/g. The pore volume of the porous silica indicates the pore volume of the porous silica itself, and refers to the volume occupied by the pores in the porous silica from among the volume occupied by the porous silica. The pore volume of the porous silica satisfies the herein-described range, so the oxide is easily impregnated, which is an advantage.

When the pore volume of the porous silica exceeds the upper value of the aforementioned range, there is a problem that the gas removal efficiency is deteriorated because the area occupied by the internal pores is excessively large. When the pore volume of the porous silica is outside the lower value of the range, it is difficult to impregnate the oxidizing agent.

In an embodiment, the porous silica may form at least one pore 15111P in the matrix 15111A. The at least one pore 15111P is formed when the porous silica is agglomerated and the matrix 15111A is formed. The porous silica may form at least one pore 15111P in the matrix 15111A so that an oxidizing agent may be easily immersed therein.

In an embodiment, a size of the pore 15111P may be 2 to 50 nm. The size of the pore 15111P represents the size of the pore of the porous silica. As used herein, “pore size” refers to the diameter of the opening or gap between two walls of a pore within a material. It should be understood that an individual pore in the porous silica may be outside the range, with the overall (or average or mean) pore size being within the scope of the present embodiments. The size of the pore 15111P may be 5.5 to 20 nm. As the size of the pore 15111P satisfies the herein-described range, the oxidizing agent 15111B may be appropriately applied into the pore 15111P so that composite for a chemical filter 15111 in which the oxidizing agent is impregnated in the matrix 15111A may be easily formed, and accordingly, the removal efficiency of the chemical contaminants such as nitrogen monoxide may be improved.

When the size of the pore 15111P is outside the upper value of the range, the size of the pore is excessively large, and the removal efficiency of the chemical contaminants is deteriorated due to a structural collapse of the composite. When the size of the pore 15111P is outside the lower value of the range, the size of the pore is excessively small so it is not impregnated on the oxidizing agent 15111B and the removal efficiency of the chemical contaminants is deteriorated.

The manganese-based oxide 15111B may be an oxidizing agent. The oxidizing agent may cause an oxidation reaction with a harmful chemical material in the air and may converts it into a harmless material. The oxidizing agent may remove the harmful chemical materials such as hydrogen sulfide (H₂S), sulfur dioxide (SO₂), ammonia (NH₃), formaldehyde (HCHO), nitrogen monoxide (NO), and/or nitrogen dioxide (NO₂).

In an embodiment, the manganese-based oxide 15111B may be at least one manganese-based oxide selected from potassium permanganate (KMnO₄) and/or sodium permanganate (NaMnO₄). The manganese-based oxide 15111B may be, for example, potassium permanganate (KMnO₄). The potassium permanganate may be useful in removing the nitrogen monoxide (NO), particularly from among the herein-described harmful chemical materials.

In an embodiment, the manganese-based oxide 15111B may be impregnated in the matrix 15111A. The manganese-based oxide 15111B may be impregnated in at least one pore 15111P in the matrix 15111A. The manganese-based oxide 15111B may be coated on a predetermined region inside a pore of the at least one pore 15111P formed while the porous silica in the matrix 15111A is agglomerated.

In an embodiment, the manganese-based oxide 15111B may include 1.5 to 15.0 parts by weight of solid manganese-based oxide with respect to 100 parts by weight of the porous silica. The porous silica may be included by 5.0 to 12.0 parts by weight, for example, 7.0 to 10.0 parts by weight. The content of the porous silica and the manganese-based oxide 15111B may represent the content of active ingredients remaining when all moisture is evaporated.

As the contents of the porous silica and the manganese-based oxide include the herein-described range, the composite having improved rigidity of the composite for a chemical filter 15111 and the removal efficiency of the contaminants may be provided. When the content of the manganese-based oxide 15111B exceeds the upper value in the herein-described range, the content of the oxidizing agent becomes excessively large, which reduces the rigidity of the composite for a chemical filter 15111 and causes the composite for a chemical filter 15111 to become deformed. When the content of the manganese-based oxide 15111B is outside the lower value in the range, the content of the oxidizing agent may become excessively small, thereby deteriorating the gas removal performance of the composite for a chemical filter 15111.

In an embodiment, an average particle diameter D50 of the composite for a chemical filter 15111 may be 0.8 to 2.0 mm. The average particle diameter D50 represents the particle diameter when the entire sample volume of the composite for a chemical filter 15111 reaches 50%. The average particle diameter D50 may be for example 0.8 to 1.5 mm, 0.9 to 1.2 mm or 1.0 to 1.18 mm.

As the average particle diameter of the composite for a chemical filter 15111 satisfies the range, the filling density of the composite for a chemical filter 15111 in the charging layer 151 may be improved, thereby improving the removal performance of the chemical material. When the average particle diameter exceeds the upper value of the range, the filling density decreases and the removal performance of the chemical material deteriorates. When the average particle diameter is outside the lower value of the range, the filling density increases, but the ratio of impregnated manganese-based oxide 15111B in the composite for a chemical filter 15111 decreases and the removal performance of the chemical material deteriorates.

In an embodiment, the composite for a chemical filter 15111 may have an amorphous peak value in an XRD peak value. For example, the composite for a chemical filter 15111 has manganese-based oxide 15111B impregnated therein, and in the XRD peak value, the peak value of the manganese-based oxide 15111B is not expressed, and the amorphous peak, which is the peak value of the matrix 15111A including porous silica, is expressed. The amorphous peak may indicate an amorphous porous silica rather than the peak of the manganese-based oxide in the composite.

Regarding the XRD peak value of the composite for a chemical filter 15111, the peak corresponding to the manganese-based oxide 15111B is not expressed and the amorphous peak value is expressed so that the manganese-based oxide 15111B may be easily impregnated in the pore 15111P of the matrix 15111A including porous silica of the composite for a chemical filter 15111, thereby providing the composite for a chemical filter 15111 having excellent rigidity and easily removing the contaminants.

In an embodiment, the composite for a chemical filter 15111 may satisfy Equation 1.

$$4.2 \leq {W}_{Mn} / P {V}_{Si} \leq 20 \qquad < Equation 1 >$$

Here, W_{Mn} is wt % of the manganese-based oxide, and PV_{Si} is the pore volume of porous silica with respect to 100 wt % of the composite for a chemical filter.

W_{Mn} represents the wt % of the manganese-based oxide in the composite for a chemical filter 15111. PV_{Si} represents the pore volume of porous silica, and for example, it may represent the pore volume after the manganese-based oxide is impregnated in the pore of porous silica. For example, Equation 1 shows the division of wt % of the manganese-based oxide by the pore volume of porous silica in the composite for a chemical filter 15111, representing an index of removal rates of chemical materials, such as nitrogen monoxide.

Equation 1 may satisfy 4.2 to 20. For example, Equation 1 may satisfy 5.8 to 16.7, for example, 6.3 to 15.8. For example, Equation 1 satisfies the herein-described range of Equation 1, thereby having the advantage of high removal efficiency of the chemical materials such as nitrogen monoxide. When the range digresses from the upper value and the lower value of Equation 1, it is difficult to impregnate the manganese-based oxide, and the removal efficiency of the chemical materials such as nitrogen monoxide is low.

In an embodiment, the composite for a chemical filter 15111 may satisfy Equation 2.

$$0.03 \leq ( {W}_{Mn} ) \times ( ( P {V}_{Si} ) / ( {BET}_{Si} ) \times ( {P}_{si} ) \leq 0.820 \qquad < Equation 2 >$$

Here, W_{Mn} represents wt % of the manganese-based oxide with reference to 100 wt % of the composite for a chemical filter, PV_{Si} represents the pore volume of porous silica, BETₛᵢ represents the specific surface area of porous silica, and Pₛᵢ represents the pore size of porous silica.

Equation 2 may represent the index of the lifespan characteristic of the composite. Equation 2 may satisfy 0.030 to 0.820. For example, Equation 2 may be 0.040 to 0.690, for example, 0.050 to 0.650. As Equation 2 satisfies the herein-described range, the removal efficiency on the chemical material of the composite for a chemical filter may be increased, and the lifespan characteristic may be increased. When Equation 2 is out of the range, the removal efficiency on the chemical material and the lifespan characteristic are deteriorated.

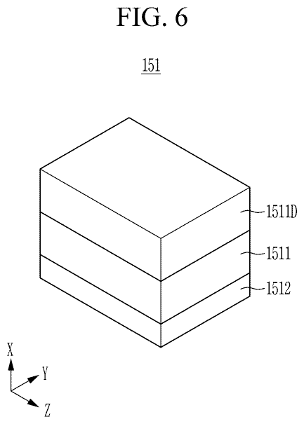

FIG. 6 shows an enlarged perspective view of a chemical filter 151 according to another embodiment of the present disclosure.

Referring to FIG. 6, in an embodiment, the chemical filter 151 may include a charging layer 1511, a dummy charging layer 1511D, and a buffer layer 1512. The chemical filter 151 may include a charging layer 1511 including at least one composite for a chemical filter 15111, a dummy charging layer 1511D for increasing the removal efficiency on the contaminants of the charging layer 1511 and assisting removal of the contaminants of the charging layer 1511, and a buffer layer 1512 arranged on at least one surface of the charging layer 1511 and the dummy charging layer 1511D and supporting the charging layer 1511 and the dummy charging layer 1511D. Detailed descriptions on the charging layer 1511 and the buffer layer 1512 may refer to the content given with reference to FIG. 5 within a compossible range.

In an embodiment, the charging layer 1511 and the dummy charging layer 1511D may include the same or similar composite for a chemical filter 15111. For example, as described with reference to FIG. 5, the charging layer 1511 and the dummy charging layer 1511D may include a composite for a chemical filter 15111 including a matrix 15111A including porous silica and a manganese-based oxide 151111B impregnated in the matrix 15111A.

As the charging layer 1511 and the dummy charging layer 1511D include the same or similar composite for a chemical filter 15111, the contaminants such as nitrogen monoxide may be more efficiently removed by the charging layer 1511 and the dummy charging layer 1511D. The charging layer 1511 and the dummy charging layer 1511D may be integrally formed or may have attachable members.

In another embodiment, the charging layer 1511 and the dummy charging layer 1511D may include different composites. The charging layer 1511 may include the composite for a chemical filter 15111 described with FIG. 5, and the dummy charging layer 1511D may include the composite with different components from those of the composite for a chemical filter 15111. For example, the dummy charging layer 1511D may use various materials such as activated carbon, zeolite, and/or potassium permanganate. The charging layer 1511 and the dummy charging layer 1511D include different materials, thereby further efficiently removing various kinds of contaminants.

In an embodiment, the charging layer 1511 and the dummy charging layer 1511D may be stacked from bottom to top in the X-axis direction, and may also be stacked in other orders. FIG. 6 shows that the charging layer 1511 and the dummy charging layer 1511D are divided into two layers and are then arranged, which is a non-limiting example, and the case of including a plurality of dummy charging layers 1511D including the same/different composite as/from the composite for a chemical filter 15111 included in the charging layer 1511 with the charging layer 1511 as an essential element may be included.

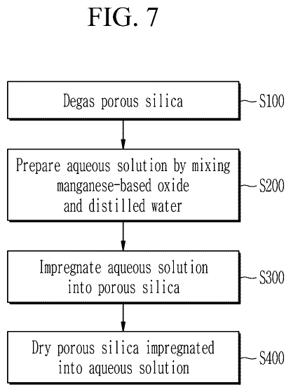

FIG. 7 shows a flowchart on a method for preparing a composite for a chemical filter according to an embodiment of the present disclosure. Referring to FIG. 7, the method for preparing a composite for a chemical filter may include: degassing porous silica (S100); preparing an aqueous solution by mixing manganese-based oxide and distilled water (S200); impregnating the aqueous solution into the porous silica (S300); and drying the porous silica into which the aqueous solution including the manganese-based oxide is impregnated (S400). The method for preparing a composite for a chemical filter may relates to a method for preparing a composite for a chemical filter in an outdoor air conditioner, and the composite for a chemical filter according to this method corresponds to the content of the composite for a chemical filter 15111 described with reference to FIG. 1 to FIG. 6 within the compossible range.

The degassing of porous silica in S100 may include removing a material such as moisture remaining in the porous silica. The degassing of porous silica may include drying the porous silica and removing the material such as moisture remaining in the porous silica or on the surface thereof. The porous silica may, for example, be silica (SiO₂), and the detailed description thereof corresponds to what is described with reference to FIG. 5 within the compossible range.

In an embodiment, the degassing of porous silica in S100 may be performed in a temperature range of 50 to 200° C. The temperature range may be 80 to 120° C. As the degassing of porous silica in the temperature range of S100 is performed, the material such as moisture remaining in the porous silica may be easily removed, and the high-quality composite for a chemical filter with excellent removal efficiency of contaminants such as nitrogen monoxide may be prepared.

When the temperature range is excessively high, structural or chemical changes in the porous silica are generated, and impregnation with an oxidizing agent may not be easily performed in the future, and thus a high-quality composite for a chemical filter may not be obtained. When the temperature range is excessively low, there is a problem that the removal effect of materials such as moisture remaining in the porous silica is insufficient.

In an embodiment, the degassing of porous silica in S100 may be performed for 9 to 20 hours. The degassing of porous silica in S100 may be performed for more than 10 hours, for example, 10 hours to 15 hours, or 11 hours to 14 hours. As the degassing of porous silica in S100 is performed within the time range, the materials such as moisture remaining in the porous silica may be easily removed so the high-quality composite for a chemical filter with excellent removal efficiency of contaminants such as nitrogen monoxide may be prepared.

When the time range is excessively high, structural or chemical changes in the porous silica are generated so impregnation with an oxidizing agent is not easily performed, making it impossible to obtain the high-quality composite for a chemical filter, or generating the problem that the porous silica reacts to the oxidizing agent. When the time range is excessively short, there is a problem that the removal effect of materials such as moisture remaining in the porous silica is insufficient.

In an embodiment, the preparing of an aqueous solution by mixing manganese-based oxide and distilled water in S200 may include preparing an aqueous solution by dissolving manganese-based oxide and distilled water. The manganese-based oxide may be at least one manganese-based oxide selected from potassium permanganate (KMnO₄) and/pr sodium permanganate (NaMnO₄), and for example, it may be potassium permanganate.

According to example embodiments, the degassing of porous silica may be performed before, during (concurrently or overlapping with), or after preparing of the aqueous solution.

In an embodiment, the manganese-based oxide may be input to be included by 1.5 to 15.0 parts by weight of the solid manganese-based oxide with respect to 100 parts by weight of the porous silica. The content of the manganese-based oxide may represent the content of the solid added as a reference to the content of the dried porous silica having undergone the degassing of the porous silica.

In an embodiment, the ratio of the weight [g] of distilled water to the weight [g] of the manganese-based oxide (the weight [g] of distilled water/the weight [g] of manganese-based oxide) is 2 to 39, for example, 2 to 11, in more detail, 3 to 8. As the weight ratio of distilled water to the weight of the manganese-based oxide satisfies the herein-described range, an aqueous solution that is easy to impregnate the manganese-based oxide into the porous silica may be formed.

When the weight ratio is outside the upper value of the aforementioned range, there is a problem that the content ratio of distilled water in the aqueous solution becomes excessively large, making it difficult to impregnate the manganese-based oxide into the porous silica during the impregnation. When the weight ratio is outside the lower value of the range, there is a problem that the content of manganese-based oxide is excessively high, making it difficult for the manganese-based oxide to be impregnated into the porous silica.

The impregnating of the porous silica with an aqueous solution in S300 may include impregnating the aqueous solution in which manganese-based oxide and distilled water are dissolved into the degassed porous silica. The impregnation may include impregnating the aqueous solution into the degassed porous silica by using an incipient wetness impregnation method. By undergoing the impregnating of the porous silica with an aqueous solution, the manganese-based oxide may be impregnated in the pores formed by the porous silica.

The drying of the porous silica impregnated with the aqueous solution containing the manganese-based oxide in S400 may be performed at a room temperature. Room temperature may be, for example, 20 to 40° C., for example, 23 to 30° C., 24 to 26° C., or 25° C.

The drying of the porous silica impregnated with the aqueous solution containing the manganese-based oxide in S400 may be performed for 6 to 24 hours. The drying may be performed for 8 hours to 18 hours, for example, 10 hours to 15 hours or 11 hours to 13 hours. By performing the drying process during the herein-described time, the manganese-based oxide may be easily impregnated into the porous silica.

When the temperature and the time excessively exceed the upper value, there is a problem in that the oxidizing agent reacts to the porous silica to deteriorate the removal efficiency of nitrogen monoxide. When the temperature and the time excessively digress from the lower value, there is a problem in that the drying is not easily performed.

Embodiments and comparative examples will now be described. However, the embodiments given herein are example embodiments, and the present invention is not limited to them.

### <Experimental Example 1>: Use of Porous Silica

### Embodiment 1

A degassing process is performed to remove gases such as moisture remaining in the porous silica. The degassing process is performed by drying 2 g of porous silica (SiO₂) in an oven at 100° C. for 12 hours. At this time, the pore volume of porous silica (SiO₂) undergoing the degassing process is 1.1 cm³/g.

The aqueous solution in which 0.15 g of potassium permanganate (KMnO₄) and 4 g of distilled water are dissolved in the degassed porous silica is supported or impregnated into the porous silica by the initial wetness impregnation method, and it is dried at the room temperature for 12 hours to prepare KMnO₄/SiO₂ impregnated with potassium permanganate in the porous silica.

At this time, the content of potassium permanganate in the composite is 7 wt % with 100 wt % of the composite as the reference, and an average particle diameter D50 of the composite is 1 to 1.18 mm. Additionally, when the composite for a chemical filter including a porous silica matrix impregnated with potassium permanganate is deposited, the pore volume is 1.0 cm³/g, the specific surface area is 410 m²/g, and the pore size is 8 nm.

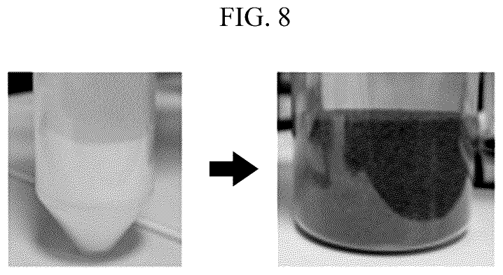

FIG. 8 shows a photograph before/after impregnation of a catalyst in a method for preparing a composite for a chemical filter according to an embodiment and a comparative example of the present disclosure.

Referring to FIG. 8, changes of colors before and after impregnation of porous silica into potassium permanganate that is an oxidizing agent are shown. It is confirmed that, when the aqueous solution containing potassium permanganate is impregnated into porous silica, the same is changed into purple particles.

### Comparative Example 1

The composite is prepared in the same manner as in the Embodiment 1, except that alumina (Al₂O₃) is used instead of the porous silica (SiO₂), and the content of potassium permanganate (KMnO₄) in the composite is 7.4 wt % with reference to 100 wt % of the composite. The average particle diameter D50 of the composite is 1 to 2 mm.

### Comparative Example 2

The composite was manufactured in the same manner as in the Comparative Example 1, except that the content of potassium permanganate (KMnO₄) in the composite is 6 wt % with respect to 100 wt % of the composite, and the average particle diameter D50 of the composite is 2 to 2.5 mm.

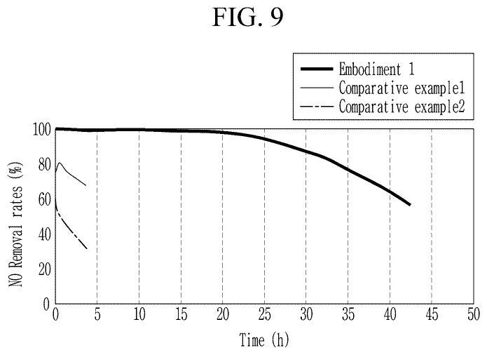

FIG. 9 shows a graph on removal efficiency of NO with respect to time according to an embodiment and a comparative example of the present disclosure.

Referring to FIG. 9, the composite prepared according to the Embodiment 1, the Comparative Example, and the Comparative Example 2 is measured by a NOₓ analyzer device in the conditions of 1 ppm of nitrogen monoxide, the room temperature (25° C.), and 50% of relative humidity, and measurement intervals are set to be 1 time/minute to measure the removal efficiency of nitrogen monoxide. In this instance, 0.5 g of the composite is used. Accordingly, regarding the removal efficiency of nitrogen monoxide of the embodiment 1, the comparative example 1, and the comparative example 2, it is found that the removal efficiency of nitrogen monoxide of the embodiment is 90% or higher even after 25 hours, and that the removal efficiency of nitrogen monoxide is 50% or higher even after 40 hours. In contrast, it is found in the Comparative Example 1 and the Comparative Example 2 that the removal efficiency of nitrogen monoxide rapidly decreases after 5 hours.

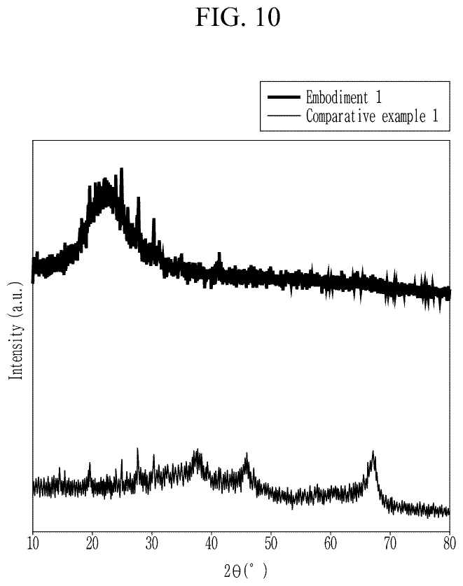

FIG. 10 shows an XRD graph on a composite for a chemical filter according to an embodiment and a comparative example of the present disclosure.

Referring to FIG. 10, it is found that, when the XRD graph for the composite for a chemical filter prepared according to the Embodiment 1 and the Comparative Example 1 is checked, in the case of the Embodiment 1, an amorphous peak is confirmed by the porous silica, and no peak by the potassium permanganate, which is an oxidizing agent is confirmed. In contrast, it is found in the comparative example 1 that no amorphous peak is generated. It was determined that this is expressed as the supporter is changed to alumina from amorphous porous silica.

### <Experimental Example 2>: Pore Volume Control of Porous Silica

### Embodiment 2

After impregnation, the process is performed in the same way as the Embodiment 1, except that the final product uses the porous silica (SiO₂) having the pore volume of 1.1 cm³/g, the specific surface area of 350 m²/g, and the pore size of 20 nm.

### Embodiment 3

After impregnation, the process is performed in the same way as the Embodiment 1, except that the final product uses the porous silica (SiO₂) having the pore volume of 0.6 cm³/g, the specific surface area of 500 m²/g, and the pore size of 6 nm.

### Comparative Example 3

After impregnation, the process is performed in the same way as the Embodiment 1, except that the final product uses the porous silica (SiO₂) having the pore volume of 1.7 cm³/g, the specific surface area of 300 m²/g, and the pore size of 15 nm.

### Comparative Example 4

After impregnation, the process is performed in the same way as the Embodiment 1, except that the final product uses the porous silica (SiO₂) having the pore volume of 0.3 cm³/g, the specific surface area of 600 m²/g, and the pore size of 5 nm.

### <Experimental Example 3>: Condition Control (Content Control of Porous Silica and Manganese-Based Oxide)

### Embodiment 4

The process is performed in the same way as the Embodiment 1, except that the weight ratio (porous silica[g]:manganese-based oxide[g]) of porous silica (SiO₂) and potassium permanganate (KMnO₄) that is manganese-based oxide is changed to 2:0.22. The weight of porous silica (SiO₂) represents the weight of porous silica (SiO₂) having undergone the degassing process.

### Embodiment 5

The process is performed in the same way as the Embodiment 1, except that the weight ratio (porous silica[g]:manganese-based oxide[g]) of porous silica (SiO₂) and potassium permanganate (KMnO₄) which is manganese-based oxide is changed to 2:0.11. At this time, the weight of porous silica (SiO₂) refers to the weight of porous silica (SiO₂) having undergone the degassing process.

### Comparative Example 5

The process is performed in the same way as the Embodiment 1, except that the weight ratio (porous silica [g]:manganese-based oxide [g]) of porous silica (SiO₂) and potassium permanganate (KMnO₄) which is manganese-based oxide is changed to 2:0.35. The weight of porous silica (SiO₂) refers to the weight of porous silica (SiO₂) having undergone the degassing process.

### Comparative Example 6

The process is performed in the same way as the embodiment 1, except that the weight ratio (porous silica[g]:manganese-based oxide[g]) of porous silica (SiO₂) and potassium permanganate (KMnO₄) which is manganese-based oxide was changed to 2:0.02. The weight of porous silica (SiO₂) represents the weight of porous silica (SiO₂) having undergone the degassing process.

### <Estimation Example>: No Removal Efficiency and Lifespan Effects.

Table 1 shows the removal efficiency of nitrogen monoxide and lifespan characteristics when the pore volume of porous silica, the specific surface area of porous silica, and the pore size of porous silica are controlled.

In Table 1, the pore volume of porous silica, the specific surface area of porous silica, the pore size of porous silica, the removal efficiency of nitrogen monoxide, and the lifespan characteristic are measured using the method herein.

The pore volume of porous silica: It is measured by the N₂-adsorption and desorption method using a Brunauer-Emmett-Teller (BET) device, and the pore volume of porous silica is measured in the same way in the composite which is the final product. The pore volume of porous silica represents the pore volume of porous silica measured when the manganese-based oxide is impregnated.

The specific surface area of porous silica: It is measured by the N₂-adsorption and desorption method using the Brunauer-Emmett-Teller (BET) device, and the specific surface area of porous silica is measured in the same way in the composite which is the final product.

The pore size of porous silica: It is measured by the N₂-adsorption and desorption method using the Brunauer-Emmett-Teller (BET) device, and the pore size of porous silica is measured in the same way in the composite which is the final product.

The removal efficiency of nitrogen monoxide: The initial removal efficiency is measured using a NOₓ analyzer device using the method of (calculate with (inlet NOₓ−outlet NOₓ)/inlet NOₓ×100%).

The lifespan characteristic: The time until the lifespan is reduced to 30% in comparison to an initial activity is determined as a catalyst lifespan by using a NOₓ analyzer device.

TABLE 1

| | Process conditions | | | Product characteristics | | | | | | | |
|---|---|---|---|---|---|---|---|---|---|---|---|
| | | | Manga- | | | BET | | | | | |
| | | | nese-based | | | porous | | | | | |
| | | | oxide | Manga- | Porous | silica | | | | | |
| | | Manga- | content | nese-based | silica | specific | Porous | | | | |
| | Porous | nese-based | [g]/porous | oxide | pore | surface | silica | | | NO | |
| | silica | oxide | silica | content | volume | area | pore size | | | removal | Life |
| | content | content | content | (W_{Mn}) | (PV_{Si}) | (BET_{Si}) | (Pₛᵢ) | Equa- | Equa- | efficiency | span |
| | [g] | [g] | [g] | [wt %] | [cm³/g] | [m²/g] | [nm] | tion 1* | tion 2** | [%] | [h] |
| Embodiment 1 | 2 | 0.15 | 0.075 | 7 | 1.0 | 410 | 8 | 7 | 0.137 | 99 | 48 |
| Embodiment 2 | 2 | 0.15 | 0.075 | 7 | 1.1 | 350 | 20 | 6.4 | 0.440 | 99 | 46 |
| Embodiment 3 | 2 | 0.15 | 0.075 | 7 | 0.6 | 500 | 6 | 11.7 | 0.050 | 99 | 47 |
| Comparative | — | — | — | 7.4 | — | — | — | — | — | 75 | 26 |
| Example 1 | | | | | | | | | | | |
| Comparative | — | — | — | 6 | — | — | — | — | — | 59 | 5 |
| Example 2 | | | | | | | | | | | |
| Comparative | 2 | 0.15 | 0.075 | 7 | 1.7 | 300 | 15 | 4.1 | 0.595 | 98 | 30 |
| Example 3 | | | | | | | | | | | |
| Comparative | 2 | 0.15 | 0.075 | 7 | 0.3 | 600 | 5 | 23.3 | 0.018 | 97 | 36 |
| Example 4 | | | | | | | | | | | |
| Embodiment 4 | 2 | 0.22 | 0.11 | 10 | 1.0 | 400 | 8 | 10 | 0.2 | 98 | 41 |
| Embodiment 5 | 2 | 0.11 | 0.06 | 5 | 1.0 | 420 | 9 | 5 | 0.107 | 95 | 40 |
| Comparative | 2 | 0.35 | 0.18 | 15 | 0.7 | 360 | 6 | 21.4 | 0.175 | 96 | 37 |
| Example 5 | | | | | | | | | | | |
| Comparative | 2 | 0.02 | 0.01 | 1 | 1.1 | 450 | 10 | 0.9 | 0.024 | 98 | 19 |
| Example 6 | | | | | | | | | | | |

*Equation 1: (W_{Mn})/(PV_{Si})
**Equation 2: (W_{Mn}) × ((PV_{Si})/(BET_{Si})) × (Pₛᵢ)

Referring to Table 1, it is found according to the Embodiment 1, the Comparative Example 1, and the Comparative Example 2 that the Embodiment 1 in which the oxidizing agent is impregnated in the porous silica has better NO removal efficiency and lifespan characteristic than the composite using the alumina and the oxidizing agent.

At this time, it was confirmed that the lifespan characteristic is excellent when the time is 40 hours or more.

According to the Embodiment 2, the Embodiment 3, the Comparative Example 3, and the Comparative Example 4, it is found that the removal efficiency of NO and the lifespan characteristic are excellent when the condition of the porous silica is included in the range of the present disclosure. According to the Embodiment 4, the Embodiment 5, the Comparative Example 5, and the Comparative Example 6, it is found that the removal efficiency of NO and the lifespan characteristic are excellent when the ratio of the content of the manganese-based oxide and the content of the porous silica are included in the range of the present disclosure.

While this disclosure has been described in connection with what is presently considered to be practical embodiments, it is to be understood that the invention is not limited to the disclosed embodiments and/or the examples, but, on the contrary, is intended to cover various modifications and equivalent arrangements included within the spirit and scope of the appended claims. Therefore, the embodiments and/or the examples described herein are only examples and should not be construed as being limitative in any respects.

### DESCRIPTION OF SYMBOLS

100: outdoor air conditioner
110: prefilter portion
120: preheater
130: temperature adjuster
140: blower
150: filter portion
151: chemical filter
152: hepa filter
1511: charging layer
1512: buffer layer
15111: composite for chemical filter
15111A: porous silica
15111B: manganese-based oxide
FAB: fab
CS: clean room
CSF: clean sub-fab
FSF: facility sub-fab

What is claimed is:

1. A composite for a chemical filter in an outdoor air conditioner comprising:
a matrix including porous silica having at least one pore; and
a manganese-based oxide impregnated in the matrix,
wherein the composite satisfies Equation 1,
$$4.2 \leq {W}_{Mn} / P {V}_{Si} \leq 20 \qquad < Equation 1 >$$
wherein W_{Mn} represents wt % of the manganese-based oxide with reference to 100 wt % of the composite for a chemical filter, and PV_{Si} represents a pore volume of porous silica.

2. The composite for a chemical filter of claim 1, wherein
the pore volume of the porous silica is 0.6 to 1.2 cm³/g.

3. The composite for a chemical filter of claim 1, wherein
the manganese-based oxide is impregnated in the matrix and arranged in a predetermined region in a pore of the at least one pore of the matrix.

4. The composite for a chemical filter of claim 1, wherein
the manganese-based oxide includes at least one manganese-based oxide selected from the group consisting of potassium permanganate (KMnO₄) and sodium permanganate (NaMnO₄).

5. The composite for a chemical filter of claim 1, wherein
a specific surface area of the porous silica is 325 to 600 m²/g.

6. The composite for a chemical filter of claim 1, wherein
a size of a pore of the at least one pore of the matrix is 2 to 50 nm.

7. The composite for a chemical filter of claim 1, wherein
the manganese-based oxide includes 1.5 to 15.0 parts by weight of a solid with reference to 100 parts by weight of the porous silica.

8. The composite for a chemical filter of claim 1, wherein
the composite satisfies Equation 2,
$$0.03 \leq ( {W}_{Mn} ) \times ( ( P {V}_{Si} ) / ( {BET}_{Si} ) \times ( {P}_{si} ) \leq 0.820 \qquad < Equation 2 >$$
wherein W_{Mn} represents wt % of manganese-based oxide with reference to 100 wt % of the composite for a chemical filter, PV_{Si} represents the pore volume of porous silica, BETₛᵢ represents a specific surface area of porous silica, and Pₛᵢ represents the pore size of the porous silica.

9. The composite for a chemical filter of claim 1, wherein
an X-ray diffraction peak value includes an amorphous peak.

10. A method for preparing a composite for a chemical filter in an outdoor air conditioner comprising:
degassing porous silica;
preparing an aqueous solution by mixing a manganese-based oxide and distilled water;
impregnating the aqueous solution in the degassed porous silica; and
drying the porous silica impregnated with the aqueous solution including the manganese-based oxide to form the composite for a chemical filter,
wherein the composite for a chemical filter satisfies Equation 1,
$$4.2 \leq {W}_{Mn} / P {V}_{Si} \leq 20 \qquad < Equation 1 >$$
wherein W_{Mn} represents wt % of the manganese-based oxide with reference to 100 wt % of the composite for a chemical filter, and PV_{Si} represents a pore volume of porous silica.

11. The method of claim 10, wherein
the manganese-based oxide includes 1.5 to 15.0 parts by weight of a solid with reference to 100 parts by weight of the porous silica.

12. The method of claim 10, wherein
the manganese-based oxide includes at least one manganese-based oxide selected from the group consisting of potassium permanganate (KMnO₄) and sodium permanganate (NaMnO₄).

13. The method of claim 10, wherein
the porous silica has pore rates of 0.6 to 1.2 cm³/g.

14. The method of claim 10, wherein
the porous silica is degassed at a temperature of 50 to 200° C.

15. The method of claim 10, wherein
the porous silica is degassed for 9 to 20 hours.

16. The method of claim 10, wherein
a ratio a weight[g] of distilled water to a weight[g] of manganese-based oxide is 2 to 39.

17. An outdoor air conditioner comprising:
a housing including an outdoor air inlet and an outdoor air outlet;
a prefilter portion in the housing, configured to filter foreign substances from outdoor air input into the housing through the outdoor air inlet;
a temperature adjuster in the housing, configured to heat or cool the outdoor air within the housing;
a blower in the housing, configured to supply the outdoor air into a semiconductor fab; and
a filter portion in the housing, configured to remove contaminants from outdoor air discharged from the blower,
wherein the filter portion includes a chemical filter configured to filter a gas phase in the contaminants,
wherein the chemical filter includes a charging layer including a composite for a chemical filter, and
wherein the composite for a chemical filter includes a matrix including porous silica and a manganese-based oxide impregnated in the matrix, and the composite satisfies Equation 1
$$4.2 \leq {W}_{Mn} / P {V}_{Si} \leq 20 \qquad < Equation 1 >$$
wherein W_{Mn} represents wt % of the manganese-based oxide with reference to 100 wt % of the composite for a chemical filter, and PV_{Si} represents a pore volume of porous silica.

18. The outdoor air conditioner of claim 17, wherein
the porous silica has pore rates of 0.6 to 1.2 cm³/g.

19. The outdoor air conditioner of claim 17, wherein
the manganese-based oxide is impregnated in the matrix and arranged in a predetermined region in a pore of the matrix.

20. The outdoor air conditioner of claim 17, wherein
the manganese-based oxide includes 1.5 to 15.0 parts by weight of solid with reference to 100 parts by weight of the porous silica.
